(19) United States
(12) Patent Application Publication
(10) Pub. No.: US 2004/0023700 A1
(43) Pub. Date: Feb. 5, 2004

(54) Self-contained portable hinge assembly

(75) Inventor: Sheel A. Gupte, Buffalo Grove, IL (US)

Correspondence Address: GREER, BURNS & CRAIN, 300 S WACKER DR, 25TH FLOOR, CHICAGO, IL, 60606, US

(73) Assignee: AMPHENOL-T&M ANTENNAS

(21) Appl. No.: 10/630,566

(22) Filed: Jul. 30, 2003

Related U.S. Application Data
(60) Provisional application No. 60/400,765, filed on Aug. 2, 2002.

(51) Int. Cl. H04M 1/00

(52) U.S. Cl. 455/575.3

(57) ABSTRACT

A self-contained hinge assembly for use in a flip device of the type having a main part and a flip part that are joined to permit opening and closing of the flip part, wherein the hinge assembly includes a cam having a biasing surface, a cam follower operationally associated the biasing surface, a biasing member for urging the cam and cam follower together and having a longitudinal axis oriented in a first direction extending from underneath the cam follower surface, a housing for closely holding at least the cam and the cam follower, and a rotatable key member operably associated with and extending from an end portion of the cam and out of the housing in a second direction that is generally perpendicular to the first direction, the key member configured to engage the flip part of the flip device.

### CROSS-REFERENCE TO RELATED APPLICATIONS

The present Application claims priority under Title 35 U.S.C. § 119 to copending Provisional Patent Application Serial No. 60/400,765, filed Aug. 2, 2002.

### FIELD OF THE INVENTION

The field of the invention is flip devices, for example personal digital assistants (PDA's) and cell phones. More particularly, the invention relates to hinges for such flip devices.

### BACKGROUND OF THE INVENTION

Because of their relative size and aesthetics, flip phones, PDA's and other flip devices are a popular form of wireless mobile communication devices. A hinge assembly connecting a main part and a flip part of such devices is generally required to hingedly connect the main and flip parts, and to provide resistance from being moved from a fully open or fully closed position. It is also desirable for the hinge assembly to assist reaching the completion of a movement of the flip part toward either a fully open or fully closed position after providing initial resistance to movement.

Typically, flip devices require a plurality of hinges, where each hinge includes one or more springs. Not only does this increase the cost and complexity of the flip device, assembly of the flip device requires a significant degree of manual dexterity when conventional hinges are used. Additionally, the amount of space consumed by the hinges on or within the flip device may preclude flip device manufacturers from including additional device features in the flip device or optimizing space in the flip device.

Cost, simplicity, ease of assembly and small size are omnipresent concerns in the design and manufacture of small portable flip devices, e.g., PDA's and wireless mobile devices. The same concerns apply to the incorporation of a hinge assembly in a flip style enclosure for a wireless mobile communication device. The concerns are exacerbated by the rapid advancement of mobile communication devices. Incorporation of additional electronics and technology requires further cost and size optimization for other components.

### SUMMARY OF THE INVENTION

The instant invention relates to a self-contained hinge assembly for use in a flip device of the type having a main part and a flip part. In one embodiment, the hinge assembly includes a cam, a cam follower, and a biasing member. At least the cam and cam follower are closely held in a housing. A key member is operably associated with the cam and extends outwardly from the housing in a direction generally perpendicular to a longitudinal axis of the housing to engage the flip part of the flip device when assembled into a flip device. The housing is preferably disposed within the main part of the flip device, while the key member extends into the flip part of the flip device to matingly engage the flip device. An automatic opening torque is preferably provided by the hinge at a predetermined angle.

### BRIEF DESCRIPTION OF THE DRAWINGS

FIG. 1 is a front elevational view of a flip telephone in which the instant invention may be used;

FIG. 2 is an exploded perspective view of a preferred embodiment of the hinge assembly of the instant invention;

FIG. 3 is a front perspective view of a first subunit of the hinge assembly illustrated in FIG. 2;

FIG. 4 is a front perspective view of a second subunit of the hinge assembly illustrated in FIG. 2;

FIG. 5 is a side perspective view of the cam of hinge assembly illustrated in FIG. 2;

FIG. 6 is a top perspective view of the cam follower of the hinge assembly illustrated in FIG. 2;

FIG. 7 is a front perspective view of the hinge assembly illustrated in FIG. 2;

FIG. 8 is a side elevational view of the hinge assembly illustrated in FIG. 2;

FIG. 9 is an exploded perspective view of a second preferred embodiment of the hinge assembly;

FIG. 10 is a side elevational view of the hinge assembly illustrated in FIG. 8; and

FIG. 11 is a side elevational view of the hinge assembly illustrated in FIG. 8.

### DETAILED DESCRIPTION OF THE INVENTION

A hinge assembly of the instant invention is contemplated for use with numerous flip devices, such as flip telephones, PDA's, or any other device having a main part and a flip part that are coupled using a hinge assembly to maintain a hinged connection between the main part and flip part of the flip telephone. A hinge assembly of the invention is also self-contained, allowing it to be assembled independently of a flip device, and then inserted during assembly of the flip device. Additionally, the instant invention provides sufficient torque and resistance to cycling failure, is simple, and meets stringent design space requirements. The hinged connection provided by the hinge assembly of the instant invention avoids the need for multiple hinges or springs, while providing the necessary initial resistance from movement away from a fully open or fully closed position and the assistance to complete movement toward the fully open and closed positions. Since only a single hinge assembly of the instant invention suffices to provide a hinged connection in the flip device, flip device manufacturers are free to include additional features within the space ordinarily occupied by a larger hinges or additional hinges, or may configure the flip device to optimize the additional space made available. For example, an LCD display that may be included in the flip device may be mounted higher within the flip device than is ordinarily possible. Additionally, once assembled, the instant hinge assembly is generally self-contained, which promotes ease of packaging, sale and transfer to a flip device manufacturer for incorporation into a specific flip device.

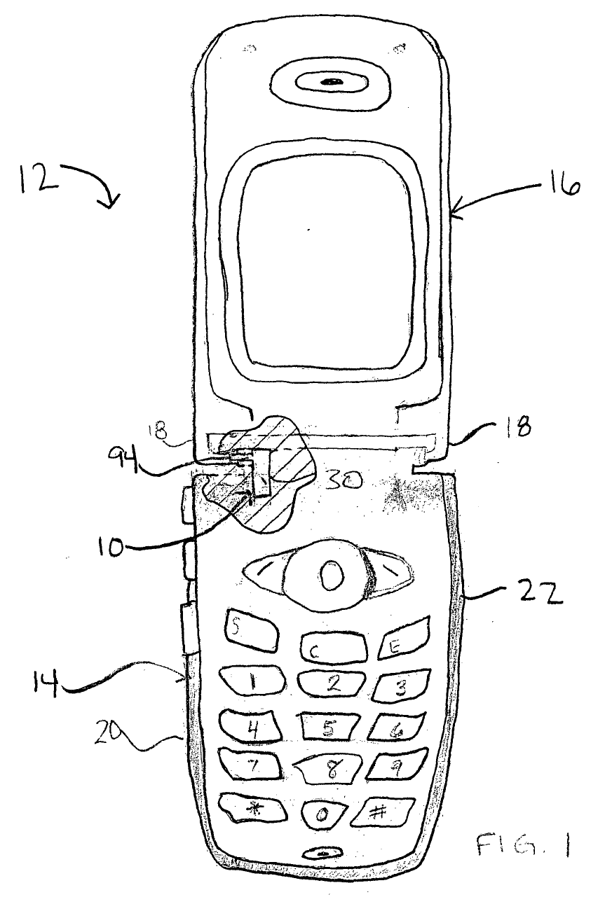

By way of example only, the instant hinge assembly will be shown in conjunction with a flip telephone. Turning now to FIG. 1, a preferred embodiment of the hinge assembly of the instant invention, designated generally at 10, is illustrated in use with a flip telephone, designated generally at 12. A main part 14 and a flip part 16 are joined to form the flip telephone 12. The flip part 16 includes two downwardly depending posts 18 that are rotatably mounted on first and second sides 20, 22 of the main part 14. In a closed position, the flip part 16 rests atop and is coextensive with at least a portion of the main part 14, while in an open position, the main and flip part are typically at an obtuse angle to one another, such as from between 100° to 180°. In addition to promoting secure rotatable mounting of the flip part 16 to the main part 14, the hinge assembly 10 of the instant invention provides a biasing force to maintain the flip telephone 12 in the open position once opened to a predetermined degree, and maintain the flip telephone in a closed position once closed to a predetermined degree.

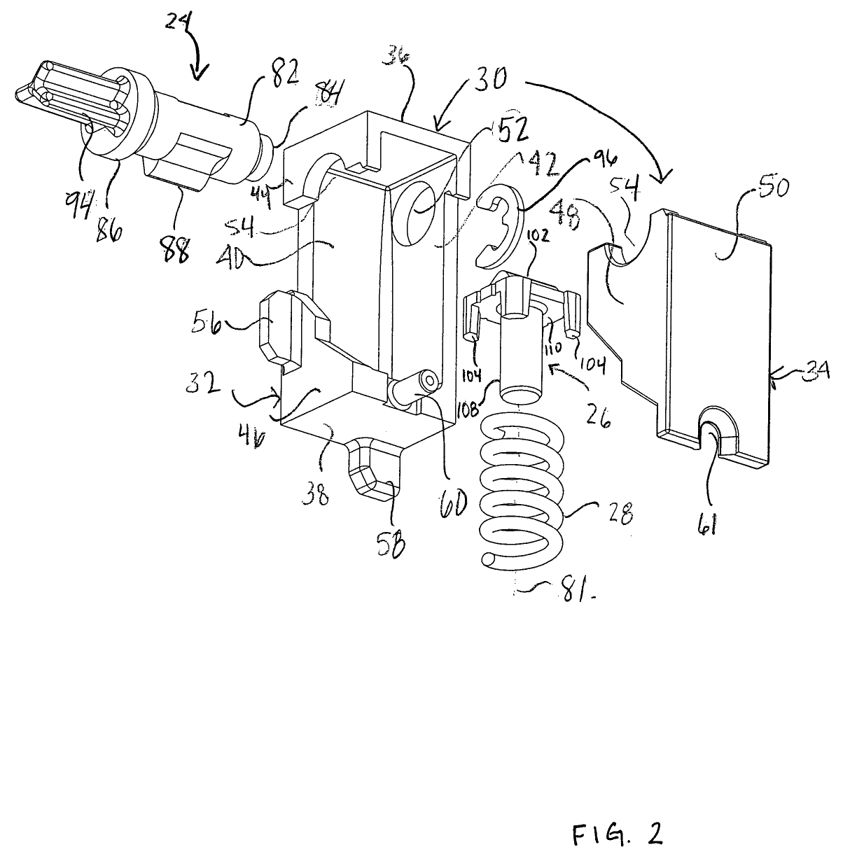

Turning now to FIG. 2, the preferred embodiment of the hinge assembly 10 of the instant embodiment includes a cam 24, a cam follower 26, and a biasing member 28 for urging the cam and cam follower together. At least the cam 24 and cam follower 26 are preferably closely held within a housing 30. The housing 30 may be configured to have numerous shapes depending on the corresponding configuration of the cam 24, cam follower 26 and biasing member 28, but in the preferred embodiment is configured to have a generally rectangular cross-section to closely hold correspondingly shaped components.

The preferred housing 30 includes a first subunit 32 and a second subunit 34 that matingly engage one another to form a single housing that preferably includes a generally rectangular cross section. In the preferred embodiment, the first subunit 32 includes generally rectangular top and bottom walls 36, 38 and two abutting side walls 40, 42 connecting the top and bottom walls. In addition, the first subunit 32 includes upper and lower portions 44, 46 of a third wall. To complete the generally rectangular housing 30, the second subunit 34 includes two abutting side walls 48, 50, which when coupled to the first subunit 32 form the housing. Side wall 42 includes a generally circular first window 52 at an upper end thereof, while each of the upper portion 44 of the third wall and side wall 48 include a generally hemispherical opening such that when the two subunits 32, 34 are coupled to one another, the hemispherical openings form a single generally circular second window 54.

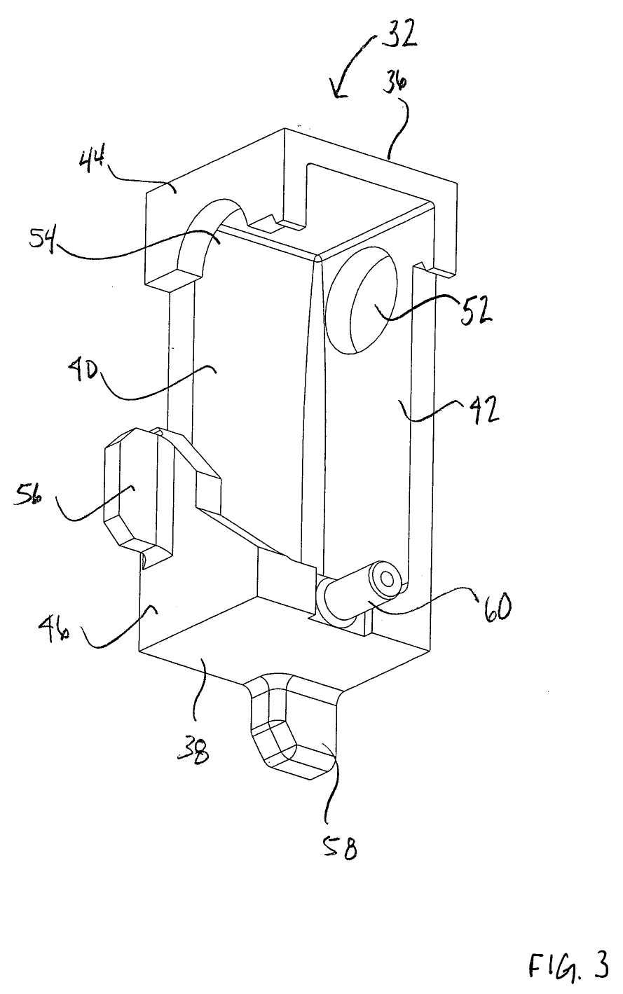

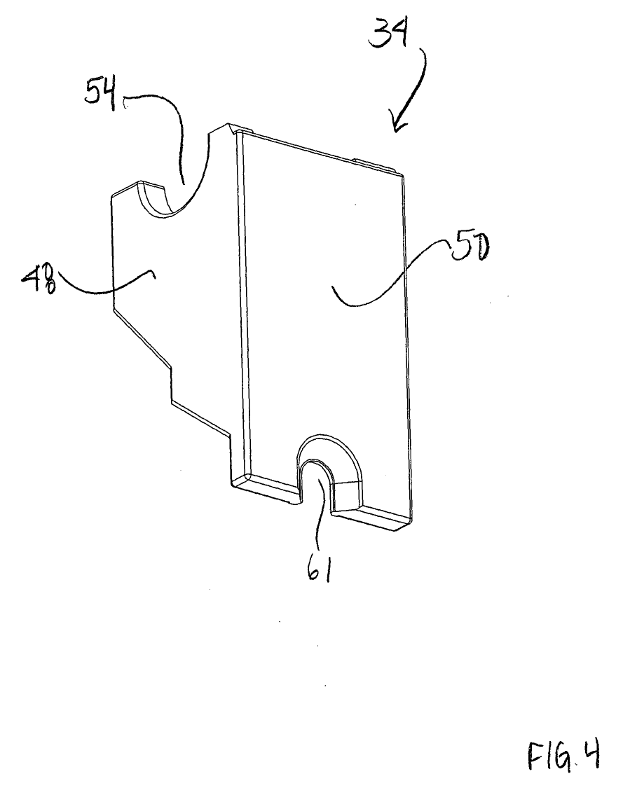

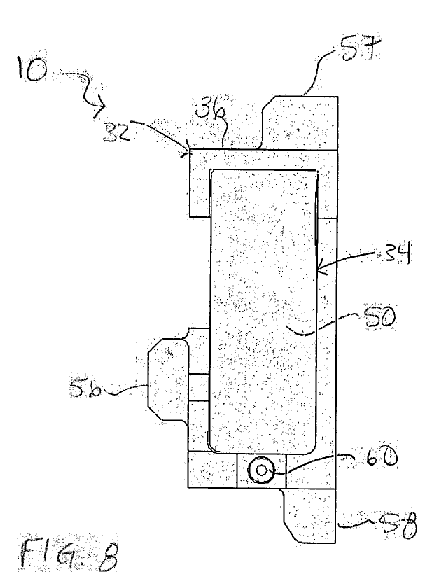

In this manner, the generally hollow housing 30 having a rectangular cross section is formed, wherein the opposing side walls 42, 48 each include a generally circular window 52, 54. The housing 30 of the instant invention may be varied to suit individual applications, and may accordingly include additional features that promote coupling of the hinge assembly 10 to the flip telephone 12. For example, in the preferred embodiment illustrated in FIGS. 2 and 3, the first subunit 32 includes a generally planar first tab 56 extending outwardly from the lower portion 46 of the third wall in direction perpendicular to the third wall, a generally planar second tab 57 (shown in FIG. 8) extending outwardly from the bottom wall 38 in a direction perpendicular to the bottom wall, and a generally planar third tab 58 that extends from the side wall 42. When assembled to the flip telephone 12, the first, second and third tabs 56, 57, 58 are matingly received by projections (not shown) in the main part 14 of the flip phone 14 that are configured to receive the tabs in a preferably snap-fit engagement.

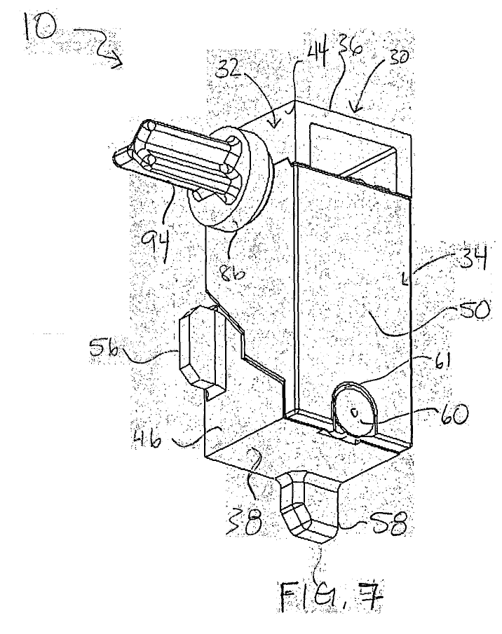

To further promote coupling of the hinge assembly to the flip telephone, the first subunit 32 preferably includes a generally cylindrical post 60 extending from a bottom front portion of the first subunit 32. To accommodate the post 60, the second subunit 34 includes a correspondingly sized and configured recess 61 within side wall 50 to allow passage of the post. Once the first and second subunits 32, 34 are coupled to one another, the post 60 is preferably orbital riveted to maintain secure engagement of the subunits to on another. The process of orbital riveting alters the shape of the post 60 into a generally planar, generally circular shape that is flush with the side wall 50, as illustrated in FIG. 7. The orbital rivet provides an adequate clamping force to maintain coupling of the second subunit 34 to the first subunit 30, and prevents displacement of the second subunit that may ordinarily occur due to high internal forces by the follower 26 on an inside wall of the second subunit.

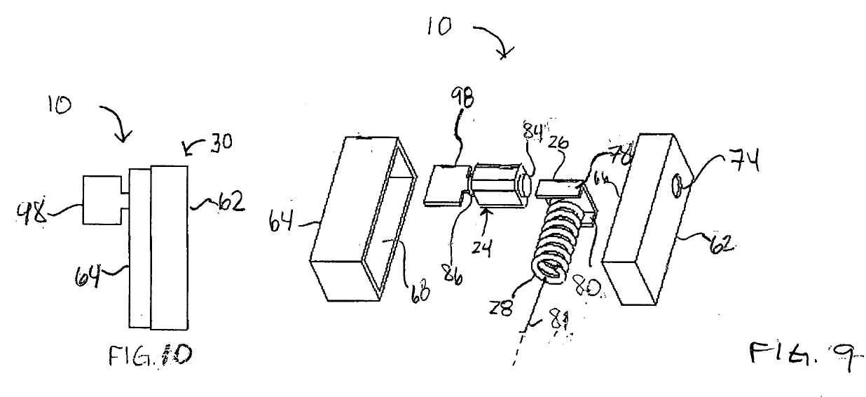

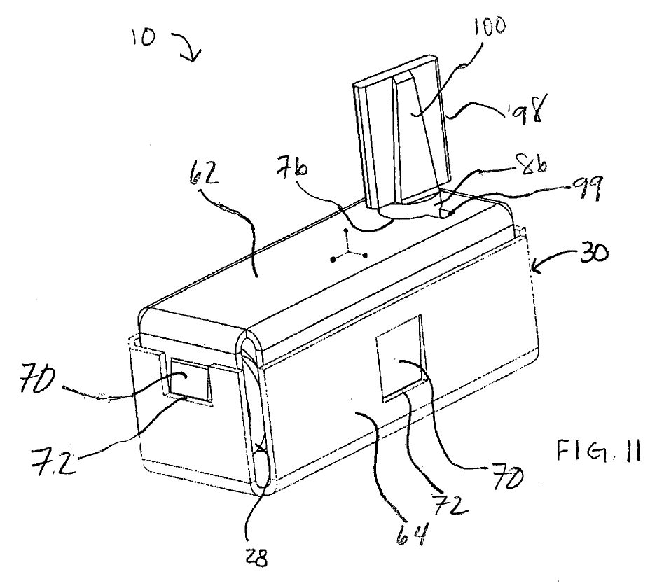

A second preferred embodiment of the housing 30 is illustrated in FIGS. 9-11 wherein a first and second subunit 62, 64 are each configured to be generally hollow, generally rectangular subunits having a respective open side 66, 68. The first subunit 62 is configured to have a slightly smaller circumference than the second subunit 64 so that the first subunit may nest within the second subunit to form an enclosure, with the open sides 66, 68 opposing one another. In this configuration, the first and second subunits 62, 64 frictionally engage one another. Additionally, each of the first and second subunits 62, 64 may optionally include respective mating snap-fit members 70, 72 for releasably securing the first and second subunits to one another. When assembled, housing 30 of this alternative embodiment is a generally hollow, generally rectangular structure having first and second windows 74, 76 disposed within side walls 78, 80 thereof. The first and second windows 74, 76 of this embodiment are configured to be contained entirely within a unitary wall 78, 80 rather than the discrete hemispheres that are joined create the second window 54 in the preferred embodiment.

Returning to the first preferred embodiment, the housing 30 is a generally hollow, generally rectangular structure having the first and second windows 52, 54 disposed within side walls 42, 48 thereof, and including at least the first, second and third tabs 56, 57 58 and the post 60. The hollow interior of the housing 30 is sized and configured to tightly accommodate the cam 24, cam follower 26 and biasing member 28. Accordingly, the cam 24, cam follower 26 and biasing member 28 are typically oriented within the housing 30 so that a longitudinal axis 81 of the biasing member is generally parallel to a longitudinal axis of the housing, with the cam being disposed at a generally right angle thereto. Thus, rotation of the cam 24 communicates motion to the cam follower 26, which translates as vertical reciprocation of the cam follower.

The biasing member 28 associated with the instant invention may be selected from a variety of springs, including for example helical springs and compression foam elements. In the illustrated embodiment, the biasing member 28 is a helical spring having a predetermined coil pitch and compression values. Preferably, the biasing member 28 should maintain these values over fatigue testing beyond 30,000 cycles.

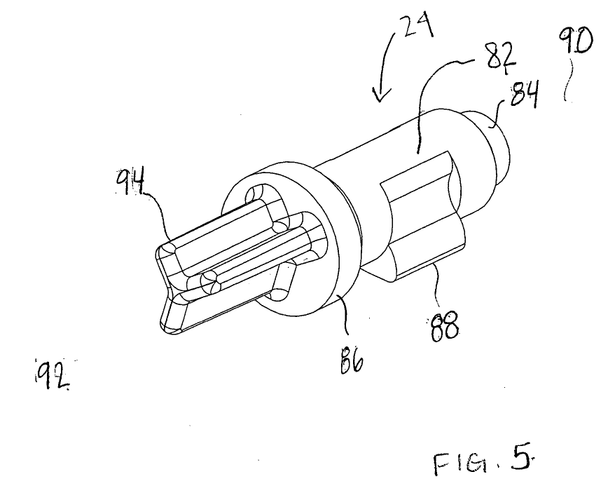

The cam 24 preferably includes a generally cylindrical camshaft 82 having a first end portion 84 and a second end portion 86 (best shown in FIG. 5). A biasing surface 88 is disposed along a portion of a circumferential surface of the camshaft 82 in an axial direction, while the remainder of the circumferential surface of the camshaft is not overlapped by the biasing surface. The biasing surface 88 may be configured in any manner that allows a longitudinal axis 90 of the camshaft 82 to be eccentric to a longitudinal center 92 of the entire cam 24.

A key member 94 extends from the camshaft 82 and through the second window 54 on the side wall 48. Because the key member 94 is disposed at the second end portion 86 of the camshaft 82, the key member will rotate with the camshaft as the camshaft rotates. The key member 94 is preferably unitary with the camshaft 82. The diameters of the first and second windows 52, 54 are sized generally to maintain the orientation of the camshaft 82 and to prevent axial movement of the camshaft. Accordingly, the second window 54 through which the key member 94 extends preferably corresponds to a diameter of the camshaft 82, and is sized and configured to be at least slightly smaller than the diameter of the second end portion 86 of the camshaft to reduce or eliminate axial movement of the camshaft in a direction of the third wall 48. Similarly, the first window 52 is sized and configured to matingly engage the first end portion 84 of the camshaft 82, which has a smaller diameter than the remainder of the camshaft 82 so that axial movement of the camshaft in the direction of the side wall 42 is restricted. Additionally, the preferred embodiment includes an axial stabilizer 96, which is preferably a C-clip, and is configured to prevent axial movement of the cam 24 as well.

Because the key member 94 extends from the hinge assembly 10 to engage the flip part 16, the key member may be configured to have any shape that will lockingly engage a corresponding recess 64 in one of the two posts 18 on the flip part. For example, as illustrated in FIG. 2, the preferred key member 94 is an elongated structure having a generally Y-shaped cross-section. Accordingly, the preferred key member 94 is matingly received by a correspondingly sized and configured recess (not shown) within the flip part 16. The preferred configuration of the key member 94 promotes a stable locking engagement with the correspondingly configured recess.

While the preferred key member 94 is illustrated in FIG. 2, the instant invention contemplates that the key member may assume a variety of shapes. For example, a key member 98 illustrated in FIG. 11 may be a generally planar, rectangular, fin-shaped extension, and may additionally include a locking ridge 100 on each of the planar surfaces. The corresponding recess 64 may be an orifice or a depression within one of the posts 18 adapted to matingly receive the key member 98.

In the embodiment illustrated in FIGS. 9, 10 and 11 wherein the windows 74, 76 are preconfigured within the walls 78, 80 and the key member 98 is a generally planar, rectangular fin-shaped extension, the windows may optionally be configured to allow passage of key member 94 through the housing 30. To this end, the second window 76 may be configured to correspond to a cross-section of the key member 98, such as including a pair of slots 99. In this manner, the key member 98 is operably associated with the camshaft 82 disposed within the housing 30, but that extends externally of the housing.

Returning to the preferred embodiment, the key member 94 extends from the second end portion 86 of the camshaft 82 while the first end portion 84 is configured to engage the first window 52 on the side wall 42. The first window 52 is preferably an orifice allowing passage of the first end portion 84 of the camshaft 82 therethrough, or may alternatively be a depression within the housing 30 that releasably secures the first end portion to the housing. Either way, the first and second end portions 84, 86 are coupled to the first and second windows 52, 54 in the housing 30, allowing rotation of the cam 24 within the housing about the longitudinal axis 90 of the camshaft, but preferably reducing or eliminating axial or transverse movement of the cam within the housing.

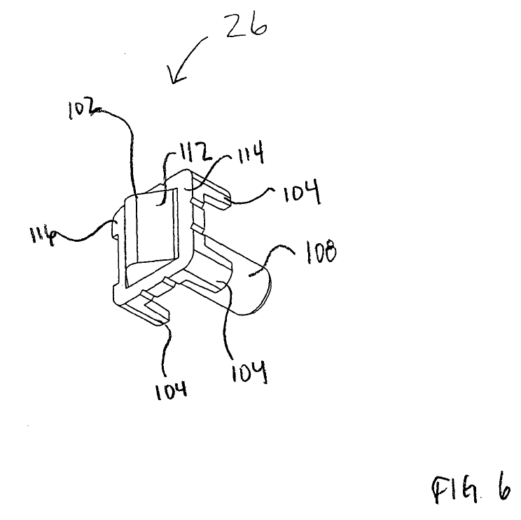

While the first and second end portions 84, 86 of the camshaft 82 are coupled to the first and second windows 52, 54 in the housing 30, the biasing surface 88 is configured and arranged to engage the cam follower 26. As illustrated in FIG. 6, the cam follower 26 of the instant invention preferably includes a follower surface 102 having a predetermined profile and a plurality of downwardly depending legs 104, preferably four, which extend downwardly from the cam follower 26 to align the cam follower within the housing 30. However, instead of including a plurality of legs 104, the cam follower 26 may be configured so that side edges of the follower surface 102 abut an internal surface of the housing 30 to maintain proper alignment of the cam follower therein. As illustrated in FIG. 9, such a configuration may be provided by including sidewalls 106 on one or more side edges of the follower surface 102.

The cam follower 26 also optionally includes an elongated shaft 108 that extends downwardly from an underside 110 of the follower surface 102, and is typically configured to nest within the center of the biasing member 28 to maintain vertical alignment of the biasing member and prevent radial distortion of the biasing member when compressed. Thus, a longitudinal axis of the elongated shaft 108 typically corresponds to the longitudinal axis 81 of the biasing member 28. Top portions of both the elongated shaft 108 and the biasing member 28 wrapped around the elongated shaft nest within the legs 104 of the cam follower 26. Thus, in addition to providing lateral stability to the follower surface 102 within the housing 30, the legs 104 promote alignment of the biasing member 28 with the follower surface.

Thus, when assembled, the housing 30 preferably includes the cam 24, cam follower 26, and biasing member 28, with the key member 94 coupled to and extending from the cam 24 through the housing 30. The housing 30 is therefore preferably sized and configured to closely hold the dimensions of at least the cam follower 26 and the cam 24. This close containment by the housing 30 of the hinge assembly 10 components promotes self-containment of the hinge assembly, facilitating easier packaging and transfer of modular hinge assembly 10 units.

Owing to the configuration of the components within the housing 30, the hinge assembly 10 of the instant invention lends itself to a simplified assembly that results in a self-contained unit that may subsequently be incorporated into a flip device. In the first preferred embodiment of the invention, wherein the housing 30 includes the first subunit 32 and the second subunit 34, assembly begins with the first and second subunits being separate from one another. The cam 24, cam follower 26 and biasing member 28 are oriented with respect to one another so that the longitudinal axis 81 of the biasing member is generally parallel to a longitudinal axis of the housing 30, with the cam being disposed at a generally right angle thereto. If the elongated shaft 108 is provided with the cam follower 26, the biasing member 28, which in the preferred embodiment is a helical spring, is coiled around the elongated shaft that extends downwardly from the underside 110 of the follower surface 102.

While maintaining this orientation, assembly of the instant hinge assembly 10 preferably proceeds by inserting the first end portion 84 of the camshaft 82 into the first window 52 and inserting the second end portion 86 of the camshaft into the second window 54. Separately, the biasing member 28 is assembled to the elongated shaft 108 of the cam follower 26. Once the biasing member 28 is coupled to the elongated shaft 108, the cam follower 26 is oriented within the housing 30 with the follower surface 102 being urged against the biasing surface 88 of the cam 24. A lubricating step preferably occurs before clamping the first and second subunits 32, 34 of the housing 30 together by orbital riveting the post 60 within the recess 61. The lubricating step preferably provides lubrication at interfaces between the cam 24 and cam follower 26, the cam follower and the second subunit 34, and the cam follower and the housing 30.

When ultimately assembled into the flip telephone 12, the housing 30 is disposed within one side of the main part 18 of the flip telephone, with the key member 58 extending into one of the pair of posts 18 on the flip part 16 of the flip telephone. Whether the first or second end portions 48, 50 of the camshaft 46 are configured to respectively engage the cam 24 or the key member 94 depends on which side of the main part 18 a flip device manufacturer elects to assemble the hinge assembly 10. In the illustrated embodiment, the housing 30 is disposed within the first side 20 of the main part 18, with the longitudinal axis of the housing parallel to a longitudinal axis of the main part. Within the housing 30, the first end 84 of the camshaft 82 engages the first window 52, and the second end 86 is coupled to the key member 94. The elongated shaft 108 preferably extends from an underside of the follower surface 110 with its longitudinal axis 81 generally perpendicular to the longitudinal axis 90 of the camshaft 82. The key member 94, which is configured to engage the corresponding recess within one of the posts 18, couples the main part 14 to the flip part 16 to maintain the main and flip parts in a hinged connection.

The biasing member 28 biases the follower surface 102 in a first position, where the follower surface is at its top most position within the housing 30. In this first position, the follower surface 102 directly abuts the circumferential surface of the camshaft 82 not overlapped by the biasing surface 88. Because the cam 24 is rotating about the longitudinal axis 90 of the camshaft 82, the radius as measured from the longitudinal axis of the camshaft to any circumferential point of the cam 24 will vary. When measured from the longitudinal axis 90 of the camshaft 82 to the circumferential surface of the camshaft that is not overlapped by the biasing surface 88, the radius of the cam 24 is smallest. However, when the radius is measured from the longitudinal axis 90 of the camshaft 82 to a top portion of the biasing surface 88 disposed upon a portion of the camshaft, the radius in greatest. Measurements for both the smallest radius and the greatest radius will vary depending on respective sizes of both the camshaft 82 and the biasing surface 88 disposed thereon. Moreover, the configuration of the biasing surface 88 will determine radius values intermediate the smallest and greatest values.

Therefore, as the cam 24 rotates along the longitudinal axis 90 of the camshaft 82, the portion of the cam contacting the follower surface 102 will vary and translate into vertical reciprocation of the follower surface 102 within the housing 30. When the camshaft 82 directly contacts the follower surface 102, the least amount of compressive force is exerted on the biasing member 28 underneath the follower surface. However, as the cam 24 rotates, the biasing surface 88 begins to contact the follower surface 102, which exerts a downward force upon the follower surface. Depression of the follower surface 102 compresses the biasing member 28 toward a second position, where the follower surface is in its lower most position within the housing 30. In the illustrated embodiment, the greatest radius of the cam 24 is measured between the longitudinal axis 90 of the camshaft 82 and the top portion of the biasing surface 88. Thus, the follower surface 102 is depressed into its second position when the top portion of the biasing surface 88 abuts the follower surface 102.

Moreover, the follower profile of the follower surface 102 may optionally be configured to maximize displacement of the follower surface and to provide the necessary initial resistance from movement away from a fully open or fully closed position and the assistance to complete movement toward the fully open and closed positions. In the illustrated embodiment, the follower surface 102 is configured to have a sloped portion 112 disposed between first and second planar edge portions 114, 116. When the camshaft 82 directly abuts the follower surface 102 at one of the planar edge portions 114, 116 the follower surface is in its first position, biased into that first position by the biasing member 28, which is not compressed. This first position may correspond to either a fully open or fully closed position of the flip telephone 12, depending upon the configuration of the hinge assembly 10. In the illustrated embodiment, the first position is the fully closed position.

As the flip part 16 is opened toward the open position, the key member 94 disposed within one of the posts 18 of the flip part begins to rotate. Consequently, the cam 24 from which the key member 94 extends begins to rotate as well. However, because the compressive forces of the biasing member 28 must be overcome for the cam 24 to complete a full revolution, there is an initial resistance to maintain the flip telephone 12 it the fully closed position. Application of sufficient force by the operator, however, will force the biasing surface 88 to engage and ascend a first slope of the sloped portion 112 and begin to overcome the compressive forces of the biasing member 28. The biasing member 28 will continue to be compressed as the biasing surface 88 rotates along the sloped portion 112 until the top portion of the biasing surface engages a peak of the sloped portion. At this point, the flip device 12 is typically intermediate the fully open and fully closed positions, and the follower surface 102 is in the second position, with the biasing member 28 maximally compressed. However, because the slope of the sloped portion 112 is configured to be even on either side of the sloped portion, there exist generally even biasing forces toward both the fully open and fully closed positions.

If the operator continues opening the flip part 16 toward the fully open position, the cam 24 will continue its original direction of rotation. As the biasing surface 88 begins to descend the slope of the sloped portion 112 opposite the slope already ascended, the same resistance forces that urged the flip device 12 to maintain the fully closed position operate to urge the flip telephone toward the fully open position. The biasing member 28 will begin to decompress, and the follower surface 102 will ascend toward its first position. Once the camshaft 82 directly abuts the follower surface 102 at the second edge portion 116, the flip telephone 12 will be in its fully open position, and is biased in the fully open position because of the same resistance forces that urged the flip telephone to maintain its fully closed position.

The size and configuration of the planar edge portions 114, 116, as well as the size and configuration of the cam 24 and its associated biasing surface 88, the degree to which a user will experience initial resistance of movement from the fully open or fully closed positions will vary. Thus, the degree to which a user must begin opening or closing the flip telephone 12 will vary depending on the size and configuration of the planar edge portions 114, 116 and the cam 24. The respective configurations of the follower surface 102 and the cam 24 result in an initial resistance to opening or closing of the flip telephone 12 up and until approximately 30° of rotation. However, it is contemplated that the follower hinge assembly 10 of the instant invention could be sized and configured to provide an initial resistance to opening or closing of the flip telephone 12 up and until any degree of rotation, such as between 25° and 80° of opening rotation.

As a corollary matter, this initial resistance also provides the biasing force that urges a partially open flip telephone 12 into the fully open position, and a partially closed flip telephone into the fully closed position. Therefore, the size and configuration of the hinge assembly 10 for considerations of initial resistance correspond to considerations for biasing forces. For example, configurations of the follower surface 102 and the cam 24 that result in an initial resistance to opening or closing of the flip telephone 12 up and until approximately 30° of rotation will similarly result in a biasing force toward either a fully open or fully closed position when 30° of rotation remain before the flip telephone 12 reaches its fully open or fully closed position.

While a specific embodiment of the present invention has been shown and others described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A self-contained hinge assembly for use in a flip device of the type having a main part and a flip part that are joined to permit opening and closing of the flip part comprising:
a cam having a biasing surface;
a cam follower operationally associated said biasing surface;
a biasing member for urging the cam and cam follower together and having a longitudinal axis oriented in a first direction extending from underneath said cam follower surface;
a housing for closely holding at least said cam and said cam follower; and
a rotatable key member operably associated with and extending from an end portion of said cam and out of said housing in a second direction that is generally perpendicular to said first direction, said key member configured to engage the flip part of the flip device.

2. The hinge assembly of claim 1 wherein said cam includes a generally cylindrical camshaft.

3. The hinge assembly of claim 1 wherein said cam follower includes a follower profile configured to include a sloped portion.

4. The hinge assembly of claim 1 wherein said cam follower is configured to promote compression of said biasing member at said sloped portion.

5. The hinge assembly of claim 1 wherein said housing is configured to be generally rectangular for closely holding said cam, said cam follower, and said biasing member.

6. The hinge assembly of claim 5 wherein said housing is configured to be disposed within the main part of the flip device in a direction generally perpendicular to an axis of rotation of the flip part.

7. The hinge assembly of claim 5 wherein said housing is configured to be disposed within a predetermined side portion of said housing.

8. The hinge assembly of claim 1 wherein said cam follower further includes a plurality of legs configured to provide lateral stability to said cam follower within said housing.

9. The hinge assembly of claim 1 wherein said cam follower further includes a plurality of legs configured to provide alignment for said biasing member with respect to said cam follower.

10. The hinge assembly of claim 1 wherein said cam follower further includes four legs configured to provide lateral stability to said cam follower within said housing.

11. The hinge assembly of claim 1 wherein said cam follower surface further includes four legs configured to provide alignment for said biasing member with respect to said cam follower.

12. The hinge assembly of claim 1 further comprising an elongated shaft extending from said cam follower in a generally perpendicular direction.

12. The hinge assembly of claim 12 wherein said biasing member is a coiled spring configured to encircle said elongated shaft.

13. The hinge assembly of claim 1 wherein said key member is an elongated shaft having a generally Y-shaped cross-section.

14. The hinge assembly of claim 1 wherein said key member is a generally planar, rectangular fin.

15. The hinge assembly of claim 1 wherein said key member is configured to matingly engage a corresponding recess disposed within the flip part of the flip device.

16. The hinge assembly of claim 1 further comprising an elongated shaft configured to depend from an underside of said cam follower surface.

17. The hinge assembly of claim 16 wherein said elongated shaft includes a longitudinal axis that corresponds to said longitudinal axis of said biasing member.

18. The hinge assembly of claim 1 wherein said hinge assembly exerts a biasing force in an open direction when said rotatable key member is rotated approximately 30° in said open direction.

19. The hinge assembly of claim 1 wherein said hinge assembly exerts a biasing force in a closed direction when said rotatable key member is rotated approximately 30° in said closed direction.

20. The hinge assembly of claim 1 wherein said housing includes a first and a second subunit.

21. The hinge assembly of claim 20 wherein said first and second subunits are configured to matingly engage one another.

22. The hinge assembly of claim 20 wherein said first and second subunits are maintained in mating engagement by orbital riveting.

23. The hinge assembly of claim 20 wherein said first subunit and said second subunit are configured to matingly engage one another in a snap-fit.

24. The hinge assembly of claim 20 wherein said first and second subunits include mating snap-fit members for releasably securing said first and second subunits to one another.

25. The hinge assembly of claim 1 wherein said cam includes an end that is configured to matingly engage a corresponding recess in said housing to releasably secure said cam to said housing.

26. A self-contained hinge assembly for use in a flip device of the type having a main part and a flip part that are joined to permit opening and closing of the flip part comprising:
a cam;
a cam follower surface;
an elongated shaft extending from said cam follower in a generally perpendicular direction;
a biasing member configured to surround said elongated shaft;
a generally rectangular housing having an orifice on at least one surface thereof, wherein said cam, said cam follower surfaces; said elongated shaft and said biasing member are disposed within said housing; and
a rotatable key member extending from said cam and through said orifice in said housing and configured to engage the flip part of the flip device.

27. A self-contained hinge assembly for use in a flip device of the type having a main part and a flip part that are joined to permit opening and closing of the flip part comprising:
a housing disposed within the main part of the flip device;
a cam assembly disposed within said housing and configured to reciprocate in a first direction; and
a rotatable key member extending outwardly from said housing from said cam assembly in a direction generally perpendicular to said first direction and configured to engage the flip part of the flip device.

28. A method of assembling a self-contained hinge assembly of the type used in a flip device having a main part and a flip part that are joined by the hinge assembly, comprising:
orienting a cam with respect to a follower surface;
orienting a biasing member with respect to said follower surface;
configuring a housing having a plurality of subunits to closely hold said cam and said follower surface;
coupling said plurality of subunits to form said housing; and
coupling a key member to said cam via a recess in said housing.

29. A method of assembling a self-contained hinge assembly of the type used in a flip device having a main part and a flip part that are joined by the hinge assembly, comprising:
orienting a cam having a key member extending from an end thereof with respect to a follower surface to communicate motion to said follower surface;
orienting a biasing member with respect to said follower surface so that said biasing member has a longitudinal axis that is generally perpendicular to an underside of said follower surface;
configuring a housing having a plurality of subunits to tightly accommodate said cam, said follower surface and said biasing member;
coupling said plurality of subunits to form said housing wherein said key member extends from a recess disposed on said housing.

30. A self-contained hinge assembly for use in a flip device that includes a housing, a cam assembly and a biasing member disposed within said housing and a key member extending from said housing, wherein both an axis of rotation of said cam assembly and an axis of rotation of said key member are normal to a longitudinal axis of said biasing member.
